(19) United States
(12) Patent Application Publication
(10) Pub. No.: US 2026/0016768 A1
(43) Pub. Date: Jan. 15, 2026

(54) IMAGE FORMING APPARATUS

(71) Applicant: KYOCERA Document Solutions Inc., Osaka (JP)

(72) Inventors: Yuta NOHARA, Osaka (JP); Minoru SHINBA, Osaka (JP)

(73) Assignee: KYOCERA Document Solutions Inc., Osaka (JP)

(21) Appl. No.: 19/261,605

(22) Filed: Jul. 7, 2025

(30) Foreign Application Priority Data
Jul. 10, 2024 (JP) 2024-110773

(51) Int. Cl. G03G 15/01; G03G 15/00; G03G 21/16

(52) U.S. Cl. CPC G03G 15/0121; G03G 15/0189; G03G 15/50; G03G 15/80; G03G 21/1647

(57) ABSTRACT

An image forming apparatus includes an image forming portion, a toner storage container, a mounting portion, a detection mechanism, and a control portion. The detection mechanism includes a first contact spring, a second contact spring, a ground line, a signal line, a power supply, a detection board and an electrically insulating key member protruding from the coupling portion of the toner container toward the coupled portion of the mounting portion. When, as a result of the toner storage container being inserted up to a mounting position, the key member moves to between the first and second contact springs so that the first and second contact springs turn from a contacting state to a non-contacting state, the control portion detects the toner storage container mounted in the mounting portion based on a change in the detection signal detected by the detecting board.

### INCORPORATION BY REFERENCE

This application is based on and claims the benefit of priority from Japanese Patent Application No. 2024-110773 filed on Jul. 10, 2024, the contents of which are hereby incorporated by reference.

### BACKGROUND

The present disclosure relates to an image forming apparatus that uses an electrophotographic process and relates in particular to an image forming apparatus provided with a toner storage container that stores toner.

In an electrophotographic image forming apparatus, toner is supplied from a developing device to an electrostatic latent image formed on the surface of an image carrying member (e.g., a photosensitive drum) to carry out a development process. The toner used in the development process is supplied to the developing device from a toner storage container.

Among image forming apparatuses provided with a toner storage container, some known image forming apparatuses have an incompatibility-sensitive structure that allows only a compatibly mountable toner container to be mounted in a container mounting portion so that incompatible toner cannot be supplied to the developing device.

### SUMMARY

According to one aspect of the present disclosure, an image forming apparatus includes an image forming portion, a toner storage container, a mounting portion, a detection mechanism, and a control portion. The image forming portion performs image formation on a recording medium using toner. The toner storage container stores the toner used in the image forming portion. In the mounting portion, the toner storage container is removably mounted. The detection mechanism detects the toner storage container mounted in the mounting portion. The control portion enables the image forming portion to perform image forming operation when the detection mechanism detects the toner storage container. The toner storage container has a coupling portion in a downstream end part of it in the insertion direction into the mounting portion. The mounting portions has a coupled portion that couples to the coupling portion when the toner storage container is inserted up to a predetermined mounting position. A detection mechanism has a detection circuit and a key member. The detection circuit includes a first contact spring provided in the coupled part, a second contact spring having a plurality of contact terminals that contact the first contact spring, a ground line to one end of which the first contact spring is connected and of which the other end is grounded, a signal line to which the second contact spring is connected, a power supply connected to the signal line, and a detection board having a detection portion that detects the voltage applied from the power supply to the signal line as a detection signal. A plurality of electrically insulating key members are provided in the coupling portion and protrude toward the coupled portion. With the toner storage container removed from the mounting position, the first contact spring and the contact terminals are in a contacting state. When the toner storage container is inserted up to the mounting position, the key member moves to between the first contact spring and the contact terminals such that the first contact spring and the contact terminals turn from the contacting state to a non-contacting state. When the first contact spring and the contact terminals turn from the contacting state to the non-contacting state, the control portion detects the toner storage container mounted in the mounting portion based on a change in the detection signal detected by the detection portion.

### BRIEF DESCRIPTION OF THE DRAWINGS

FIG. 1 is a schematic diagram showing the internal construction of an image forming apparatus according to one embodiment of the present disclosure.

FIG. 2 is an enlarged view around an image forming portion in FIG. 1.

FIG. 3 is a perspective view of toner containers and container mounting portions mounted in the image forming apparatus according to the embodiment.

FIG. 4 is a perspective view of the toner container as viewed from upstream in the insertion direction.

FIG. 5 is a sectional view of a downstream end part of the toner container in the insertion direction, as cut along the axial direction.

FIG. 6 is a sectional view of a downstream end part of the toner container in the insertion direction, as cut along the axial direction in a state where the toner container is mounted in the container mounting portion.

FIG. 7 is a perspective view of a coupling portion of the toner container.

FIG. 8 is a front view of the coupling portion of the toner container as viewed from downstream in the insertion direction.

FIG. 9 is a perspective view of a coupled portion of the container mounting portion.

FIG. 10 is an enlarged view of the coupling between a second contact spring and a second coupling spring in FIG. 9.

FIG. 11 is a perspective view of the first contact spring fitted to the coupled portion.

FIG. 12 is a perspective view of the second contact spring fitted to the coupled portion.

FIG. 13 is a plan view of the container mounting portions as viewed from the rear.

FIG. 14 is an enlarged view around the first coupling spring in FIG. 13.

FIG. 15 is a block diagram showing one example of control paths in the image forming apparatus according to the embodiment.

FIG. 16 is a schematic diagram of a container detection circuit used in the image forming apparatus according to the embodiment, showing a state where no toner containers are mounted in the container mounting portions.

FIG. 17 is a sectional view of the coupling portion of the toner container and the coupled portion of the container mounting portion as cut along the axial direction, showing a state immediately before the toner container reaches a mounting position in the container mounting portion.

FIG. 18 is an enlarged view around the first and second contact springs in FIG. 17.

FIG. 19 is a sectional view of the coupling portion of the toner container and the coupled portion of the container mounting portion as cut along the axial direction, showing a state where the toner container has been inserted up to the mounting position in the container mounting portion.

FIG. 20 is an enlarged view around the first and second contact springs in FIG. 19.

FIG. 21 is a schematic diagram of the container detection circuit, showing a state where, from the state in FIG. 16, normal toner containers have been mounted in the container mounting portions.

FIG. 22 is a schematic diagram of the container detection circuit used when the image forming apparatus is a monochrome printer, showing a state wherewith no toner containers are mounted in the container mounting portions.

FIG. 23 is a schematic diagram of the container detection circuit, showing a state where, from the state in FIG. 22, a normal tonner container has been mounted in the container mounting portion.

### DETAILED DESCRIPTION

### [1. Overall Configuration of an Image Forming Apparatus]

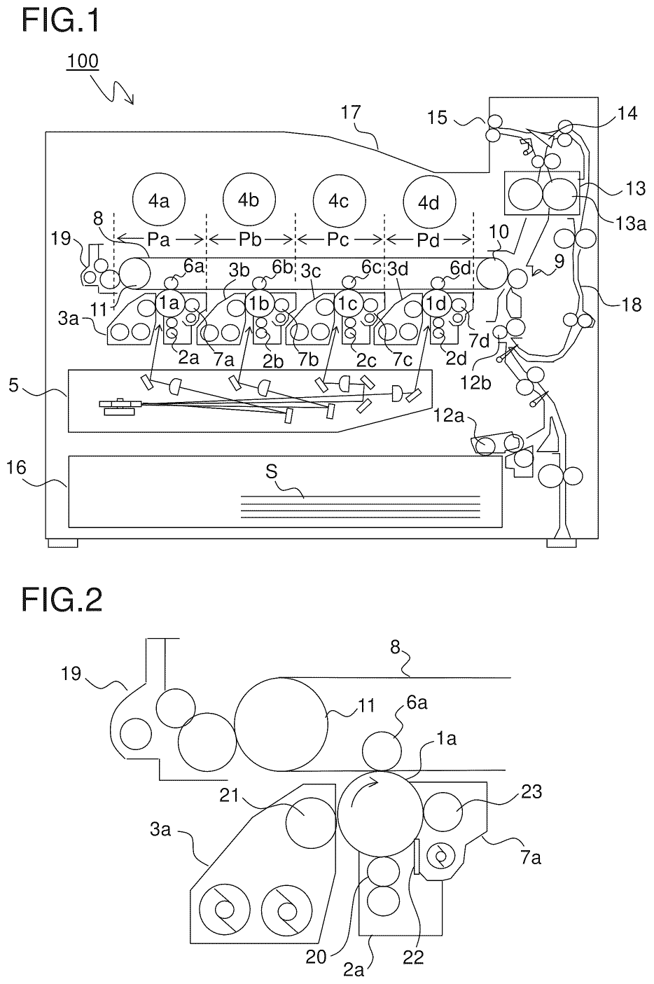

An embodiment of the present disclosure will be described below with reference to the accompanying drawings. FIG. 1 is a schematic diagram showing the construction of an image forming apparatus 100 according to one embodiment of the present disclosure. FIG. 2 is an enlarged view around an image forming portion Pa FIG. 1.

The image forming apparatus 100 shown in FIG. 1 is what is called a tandem-type color printer and has the following configuration. In a body of the image forming apparatus 100, four image forming portions Pa, Pb, Pc, and Pd are arranged in this order from upstream (left in FIG. 1) along the conveyance direction. These image forming portions Pa to Pd are provided to correspond to images of four different colors (yellow, cyan, magenta, and black) respectively, and form a yellow, a cyan, a magenta, and a black image sequentially, each through the processes of electrostatic charging, exposure to light, image development, and image transfer.

In these imaging forming portions Pa to Pd, photosensitive drums 1a, 1b, 1c, and 1d are disposed that carry visible images (toner images) of the different colors. Furthermore, an intermediate transfer belt 8 rotating in the counterclockwise direction in FIG. 1 is provided adjacent to the image forming portions Pa to Pd. The toner images formed on these photosensitive drums 1a to 1d are sequentially transferred to the intermediate transfer belt 8, which moves while in contact with the photosensitive drums 1a to 1d, and are then transferred at once to a sheet S of paper as one example of a recording medium at a secondary transfer roller 9. Furthermore, the toner images are fixed to the sheet S in a fixing portion 13, and then the sheet S is discharged out of the body of the image forming apparatus 100. With the photosensitive drums 1a to 1d rotated in the clockwise direction in FIG. 1, an image forming process is performed with respect to each of the photosensitive drums 1a to 1d.

The sheet S to which the toner images are transferred is stored in a sheet cassette 16 disposed in a lower part of the body of the image forming apparatus 100 and is conveyed to the secondary transfer roller 9 via a sheet feed roller 12a and a pair of registration rollers 12b. A belt with no seam (seamless belt) is typically used as the intermediate transfer belt 8.

Next, a description will be given of the image forming portions Pa to Pd. The image forming portion Pa will be described in detail below. For the other image forming portions Pb to Pd, which are basically configured similarly, no separate description will be given. As shown in FIG. 2, around the photosensitive drum 1a, there are disposed a charging device 2a, a developing device 3a, and a cleaning device 7a along the drum rotation direction (clockwise direction in FIG. 2), and across the intermediate transfer belt 8, a primary transfer roller 6a is disposed. Moreover, a belt cleaning unit 19 is disposed upstream of the photosensitive drum 1a in the rotation direction of the intermediate transfer belt 8, opposite a tension roller 11 across the intermediate transfer belt 8.

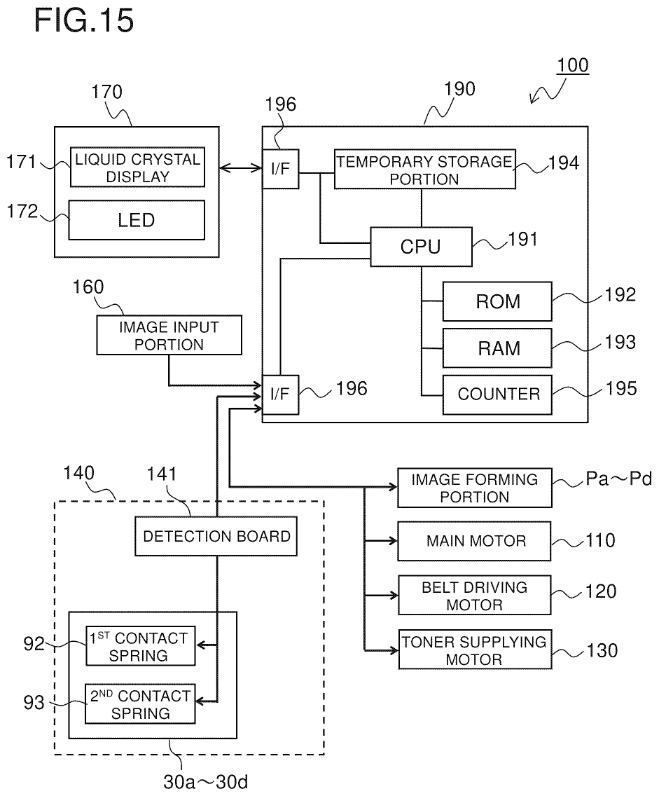

Next, a description will be given of an image forming procedure on the image forming apparatus 100. When a user enters an instruction to start image formation, first, the main motor 110 (see FIG. 15) starts to rotate the photosensitive drums 1a to 1d, and a charging roller 20 in the charging devices 2a to 2d electrostatically charges the surfaces of the photo sensitive drums 1a to 1d uniformly. Next, with a light beam (laser beam) emitted from an exposure device 5, the surfaces of the photosensitive drums 1a to 1d are irradiated so that electrostatic latent images according to an image signal are formed on the photosensitive drums 1a to 1d.

The developing devices 3a to 3d are loaded with predetermined amounts of yellow, magenta, cyan, and black toner, respectively. When, as the formation of toner images progresses as will be described later, the proportion of toner in the two-component developer loaded in the developing devices 3a to 3d falls below a prescribed value, toner is supplied from toner containers 4a to 4d to the developing devices 3a to 3d. This toner in the developer is supplied onto the photosensitive drums 1a to 1d by the developing rollers 21 in the developing devices 3a to 3d and electrostatically adheres to them. Thus, toner images are formed according to the electrostatic latent images formed by exposure to the light from the optical scanning device 5.

Then, primary transfer rollers 6a to 6d produce an electric field with a predetermined primary transfer voltage between themselves and the photosensitive drums 1a to 1d to primarily transfer the yellow, magenta, cyan, and black toner images on the photosensitive drums 1a to 1d to the intermediate transfer belt 8. These images of four colors are formed in a predetermined positional relationship previously set to form a predetermined full-color image. After that, the toner remaining on the surfaces of the photosensitive drums 1a to 1d is removed by a cleaning blade 22 and a rubbing roller 23 in the cleaning devices 7a to 7d.

When a belt driving motor 120 (see, FIG. 15) rotates a driving roller 10 and the intermediate transfer belt 8 starts to rotate in the counterclockwise direction, a sheet S is conveyed, with predetermined timing, from the pair of registration rollers 12b to the secondary transfer roller 9 provided adjacent to the intermediate transfer belt 8, and the full-color image is transferred. The sheet S having the toner images transferred to it is conveyed to the fixing portion 13. The toner remaining on the surface of the intermediate transfer belt 8 is removed by the belt cleaning unit 19.

The sheet S conveyed to the fixing portion 13 is heated and pressed by a pair of fixing rollers 13a, so that the toner images are fixed to the surface of the sheet S to form the predetermined full-color image. The sheet S having the full-color image formed on it has its conveyance direction switched by a branch portion 14 which branches into a plurality of directions, to be discharged as it is (or after being conveyed to a duplex conveyance passage 18 and subjected to duplex printing) to a discharge tray 17 by a pair of discharge rollers 15.

### [2. Configuration of Toner Containers and Container Mounting Portions]

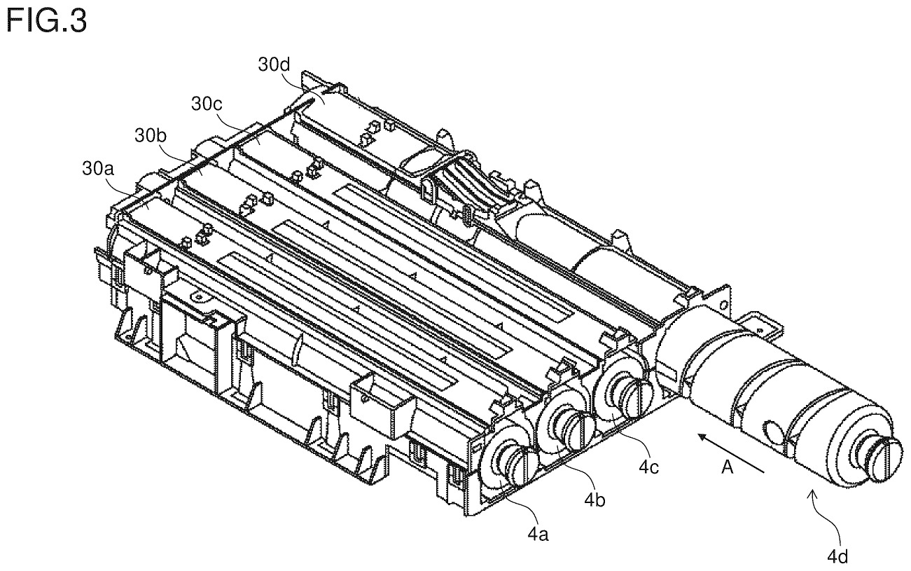

Next, the toner containers 4a to 4d and the container mounting portions 30a to 30d mounted in the image forming apparatus 100 will be described. FIG. 3 is a perspective view of the toner containers 4a to 4d and the container mounting portions 30a to 30d mounted in the image forming apparatus 100 of this embodiment. In FIG. 3, only the toner container 4d is shown as it is in the process of being mounted in the container mounting portion 30d, while the toner containers 4a to 4c are shown as they are in a state mounted in the container mounting portions 30a to 30c.

As shown in FIG. 3, the toner containers 4a to 4d are mounted in the container mounting portions 30a to 30d, respectively, along an insertion direction pointing from the front (near right in FIG. 3) to the rear (far left in FIG. 3) of the image forming apparatus 100. The container mounting portion 30a to 30d are arrayed in the left-right direction. The container mounting portions 30a to 30d are cylindrical in shape extending in the front-back direction. The outer diameter of the toner container 4d, which stores black toner, is larger than the outer diameter of the toner containers 4a to 4c, which store yellow, cyan, and magenta toner. The inner diameter of the container mounting portion 30d is larger than the inner diameter of the container mounting portions 30a to 30c.

A toner supply port 303 (see FIG. 6) is provided in a bottom part of each of the container mounting portions 30a to 30d, downstream in the insertion direction. The toner supply port 303 communicates with the inside of the developing devices 3a to 3d in the image forming portions Pa to Pd via a supply pipe 304 (see FIG. 6) extending along the up-down direction.

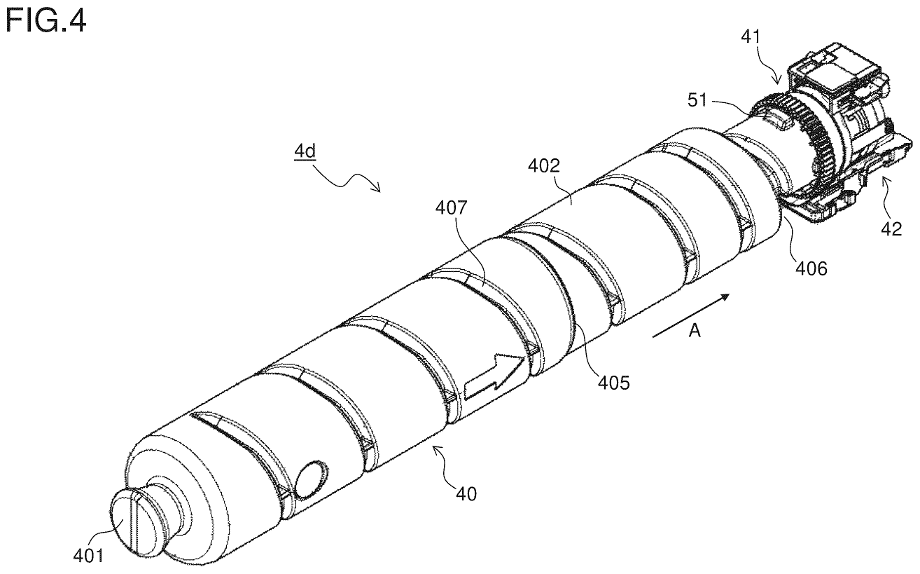

FIG. 4 is a perspective view of the toner container 4d as viewed from upstream in the insertion direction. While the following description focuses on the toner container 4d, which stores black toner, the toner containers 4a to 4c, which store yellow, cyan, and magenta toner, are configured similarly.

As shown in FIG. 4, the toner container 4d has a container body 40, a transmission gear 41 fitted to a rear part of the container body 40, and a cap member 42 provided behind the transmission gear 41.

The container body 40 is cylindrical in shape extending along its insertion direction (arrow A direction) with respect to the container mounting portion 30d. In this embodiment, the front-back direction of the image forming apparatus 100 is the longitudinal direction of the container body 40. The container body 40 is configured to be rotatable about a rotation axis Y extending in the longitudinal direction. The container body 40 stores black toner (not shown) in it. The toner stored in the container body 40 is conveyed from front to back (from upstream to downstream in the insertion direction) in the image forming apparatus 100.

The container body 40 has a handle portion 401 and a cylindrical portion 402 provided downstream of the handle portion 401 in the toner conveyance direction (arrow A direction).

The handle portion 401 is provided in an upstream end part (at lower left in FIG. 4) of the container body 40 in the insertion direction. An interior space of the handle portion 401 communicates with an interior space of the cylindrical portion 402. The cylindrical portion 402 is formed in a cylindrical shape about a rotation axis Y. A first step portion 405 substantially in an annular shape and a second step 406 in a spiral shape are formed on the outer circumferential surface of the container body 40. The level difference of the first step portion 405 is smaller than the level difference of the second step portion 406.

One conveyance rib 407 in a spiral shape is continuously provided in the inner circumferential surface of the cylindrical portion 402 of the container body 40. The conveyance rib 407 protrudes from the inner circumferential surface of the container body 40 radially inward to be substantially V-shaped as seen in a sectional view.

A pair of engaging projections 51 (movement restricting portion) are provided at the downstream end (upper right in FIG. 3) of the cylindrical portion 402 in the insertion direction. The engaging projections 51 are disposed so that neither overlaps with the conveyance rib 407.

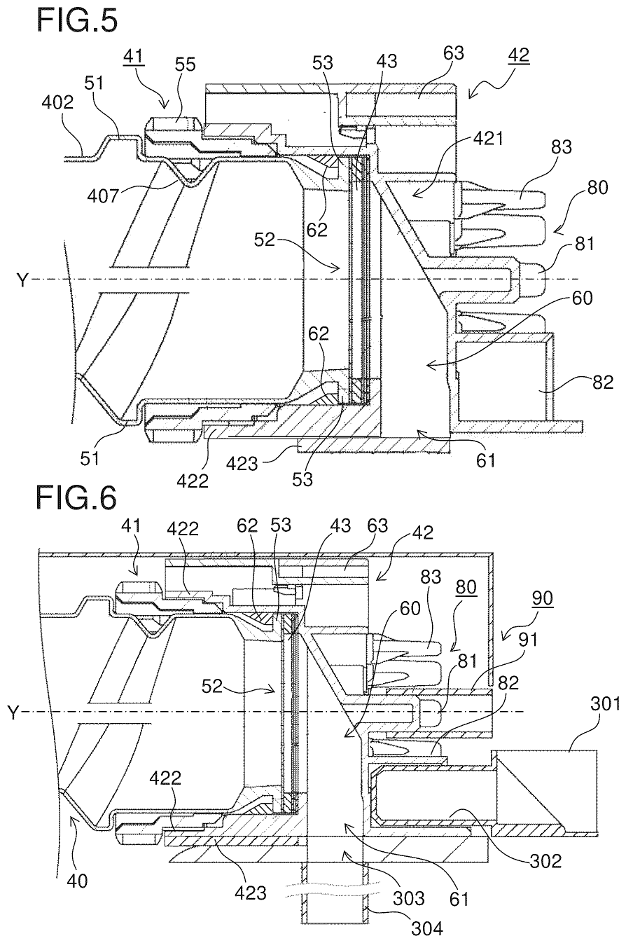

FIG. 5 is a sectional view of a downstream end part of the toner container 4d in the insertion direction, as cut along the axial direction. As shown in FIG. 5, an opening portion 52 in a circular shape is provided in a downstream end part of the cylindrical portion 402 in the insertion direction. An annular flange portion 53 protruding radially outward is provided around a circumferential part of the opening portion 52.

The transmission gear 41 is fitted on the outer circumferential surface of the cylindrical portion 402 of the container body 40. The transmission gear 41 is formed in a cylindrical shape about the rotation axis Y. The outer circumference of the transmission gear 41 is provided with gear teeth 55. An upstream end part of the transmission gear 41 with respect to the insertion direction faces the engaging projections 51 on the container body 40. The cap member 42 covers the opening portion 52 of the container body 40. The cap member 42 has a body portion 421, a holding portion 422 extending from the body portion 421 upstream in the insertion direction, a cover-side shutter 423 provided below the body portion 421 and the holding portion 422, and a coupling portion 80 formed downstream of the cap member 42 in the insertion direction.

Inside the body portion 421, a communication portion 60 is provided that communicates with a toner storage space in the container body 40 via the opening portion 52 of the container body 40. A toner discharge port 61 is provided at the lower end of the communication portion 60.

The holding portion 422 has a substantially cylindrical shape about the rotation axis Y, protruding from the body portion 421 into the container body 40. The inner circumferential surface of the holding portion 422 faces the outer circumferential surface of the transmission gear 41. The inner circumferential surface of the holding portion 422 of the cap member 42 is provided with a total of four locking portions 62. The locking portions 62 hold, in a gap between them and the body portion 421, the flange portion 53 of the container body 40 (a downstream end part of it in the insertion direction) and the sealing member 43.

The holding portion 422 holds the transmission gear 41 between it and the engagement projections 51 on the container body 40. This restricts the movement of the transmission gear 41 in the insertion direction with respect to the container body 40 and prevents the transmission gear 41 from falling off the container body 40.

The coupling portion 80 is integrally formed in a downstream end part (at right in FIG. 5) of the cap member 42 in the insertion direction. The coupling portion 80 is coupled to a coupled portion 90 (see FIG. 6) of the container mounting portion 30d. The configurations of the coupling portion 80 and the coupled portion 90 will be described in detail later.

The sealing member 43 is formed in the shape of a ring and is disposed radially inward of the holding portion 422 of the cap member 42. The sealing member 43 is disposed, in a compressed state, between the flange portion 53 of the container body 40 and the body portion 421 of the cap member 42.

Next, the operation of mounting the toner containers 4a to 4d in the container mounting portions 30a to 30d will be described. Since the mounting operation is similar for the toner containers 4a to 4d, only the operation of mounting the toner container 4d in the container mounting portion 30d will be described below, and no description will be repeated for the operation of mounting the toner containers 4a to 4c in the container mounting portions 30a to 30c.

To mount the toner container 4d in the container mounting portion 30d, as shown in FIG. 2, the toner container 4d is inserted into the container mounting portion 30d starting with a downstream (cap member 42 side) end part of the former in the insertion direction.

FIG. 6 is a sectional view of a downstream end part of the toner container 4d in the insertion direction, as cut along the axial direction in a state where the cap member 42 of the toner container 4d is fitted to the connecting portion 31 of the container mounting portion 30d. When the toner container 4d is mounted in the container mounting portion 30d, as shown in FIG. 6, a positioning projection 81 formed on the coupling portion 80 of the cap member 42 is inserted into a cylindrical boss portion 91 formed on the coupled portion 90 of the container mounting portion 30d.

An engagement cylinder portion 82 formed on the coupling portion 80 engages with a boss 302 on a mounting portion side shutter 301 formed in the coupled portion 90. In this state, the coupling portion 80 of the cap member 42 presses the boss 302, so that the mounting portion-side shutter 301 moves from a closed position to an open position, opening the toner supply port 303 of the container mounting portion 30d.

When the toner container 4d is mounted in the container mounting portion 30d, a cover-side shutter 425 provided on the cap member 42 moves from a closed position to an open position, and the toner discharge port 61 of the body portion 421 of the cap member 42 is opened. Thus, the communication portion 60 of the body portion 421 communicates with the supply pipe 304.

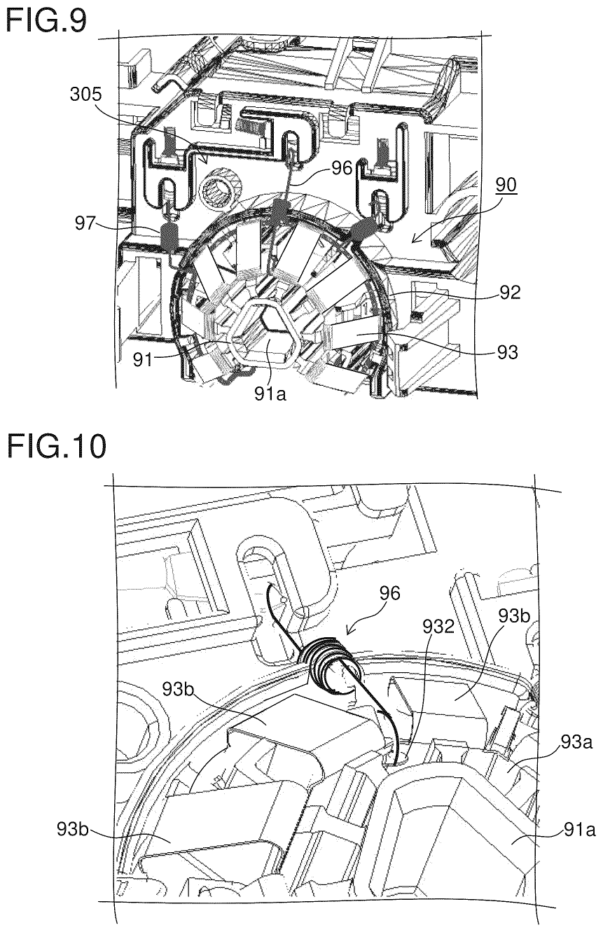

When the toner container 4d is mounted in the container mounting portion 30d as described above, a cover-side restriction portion 63 of the cap member 42 of the toner container 4d fits into a mounting portion-side restriction portion 305 (see FIG. 9) of the container mounting portion 30d.

Among the toner containers 4a to 4d, the cover-side restriction portion 63 of the cap member 42 has different shapes for different toner colors. The container mounting portions 30a to 30d have the mounting portion-side restricting portion 305 shaped according to the cover-side restricting portion 63 of the corresponding toner containers 4a to 4d respectively. Thus, the toner containers 4a to 4d can be mounted only in the corresponding container mounting portions 30a to 30d, respectively, and this prevents incorrect mounting of the toner containers 4a to 4d of the wrong toner colors in the container mounting portions 30a to 30d.

Next, the operation of supplying toner from the toner container 4d to the developing device 3d in the image forming portion Pd in the image forming apparatus 100 will be described. Since the operation of supplying toner from the toner containers 4a to 4c to the developing devices 3a to 3c in image forming portions Pa to Pc is similar, no separate description will be given.

To supply toner from the toner container 4d to the developing device 3d in the image forming portion Pd, a toner supplying motor 130 (see FIG. 15) is driven with the toner container 4d mounted in the container mounting portion 30d as shown in FIG. 6. Thus, a rotary driving force from the toner supplying motor 130 is transmitted to the transmission gear 41 of the toner container 4d via a gear train and a drive input gear (neither is shown), so that the transmission gear 41 rotates.

As the transmission gear 41 rotates, the container body 40 of the toner container 4d rotates together with the transmission gear 41. Thus, the transmission gear 41 transmits the rotary driving force from the toner supply motor 130 to the container body 40.

On the other hand, the cap member 42 and the sealing member 43 of the toner container 4d do not rotate as the container body 40 rotates and remains at rest. Thus, the container body 40 rotates relative to the cap member 42 and the sealing member 43.

As the container body 40 rotates, the toner in the container body 40 is conveyed by the conveyance ribs 407 on the container body 40 from upstream to downstream in the toner conveyance direction and is discharged from the container body 40 through the opening portion 52. The toner discharged from the container body 40 through the opening portion 52 is introduced into the communication portion 60 of the body portion 421 of the cap member 42. The toner introduced into the communication portion 60 is discharged from the communication portion 60 via the toner discharge port 61 of the body portion 421. The toner discharged from the communication portion 60 via the toner discharge port 61 is introduced into the supply pipe 304 via the toner supply port 303 of the container mounting portion 30d, and is supplied from the supply pipe 304 to the developing device 3d in the image forming portion Pd.

In this embodiment, the image forming apparatus 100 is so configured as to prevent the mounting of toner containers 4a to 4d storing unsuitable toner. That is, the image forming apparatus 100 is so configured so as to permit only such toner containers 4a to 4d as can be compatibly mounted in the corresponding container mounting portions 30a to 30d. In other words, the container mounting portions 30a to 30d allow selective mounting of compatibly mountable toner containers 4a to 4d.

Specifically, the coupling portion 80 is provided in a downstream end part of the toner containers 4a to 4d in the insertion direction. On the other hand, the coupled portion 90 is provided in a downstream end part of the container mounting portions 30a to 30d in the insertion direction. The coupling portion 80 and the coupled portion 90 constitute a discrimination mechanism for discriminating the toner containers 4a to 4d that are compatibly mountable. The discrimination mechanism is used to discriminate toner containers 4a to 4d for different places of destination, or toner containers 4a to 4d that are not genuine.

### [3. Configuration of the Coupling Portion of the Toner Container and the Coupled Portion of the Container Mounting Portion]

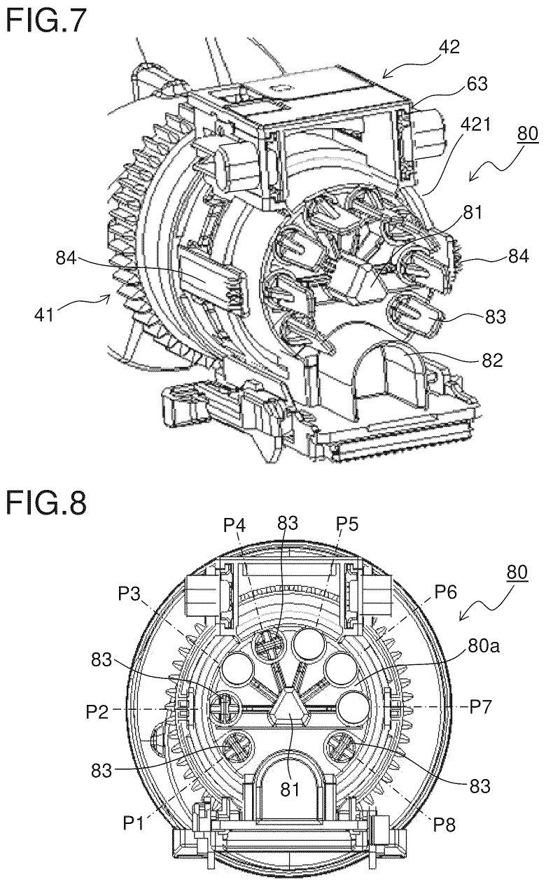

FIGS. 7 and 8 are a perspective view and a front view, respectively, of the coupling portion 80 of the toner container 4d. FIG. 9 is a perspective view of the coupled portion 90 of the container mounting portion 30d. FIG. 10 is an enlarged view of the coupling between a second contact spring 93 and a second coupling spring 96 in FIG. 9. While the coupling portion 80 of the toner container 4d and the coupled portion 90 of the container mounting portion 30d will be described below, the coupling portion 80 of the toner containers 4a to 4c and the coupled portion 90 of the container mounting portions 30a to 30c are basically configured similarly.

As shown in FIG. 7, the coupling portion 80 is provided on the downstream end surface 42a of the body portion 421 of the cap member 42 in the insertion direction. The coupling portion 80 has a positioning projection 81 and a plurality of compatible keys 83 (key members). Although FIG. 7 shows the coupling portion 80 that has compatible keys 83 formed at eight locations, the actual coupling portion 80 has compatible keys 83 formed in only four of the eight locations as shown in FIG. 8.

The positioning projection 81 is a triangular prism-shaped member protruding from the end surface 80a of the coupling portion 80 downstream in the insertion direction (toward the coupled portion 90). The compatible key 83 is a rib-shaped member protruding from the end surface 80a of the coupling portion 80 downstream in the insertion direction (toward the coupled portion 90), with a flattened tip end. The compatible key 83 is formed of an electrically insulating material (here, resin material).

As shown in FIG. 8, as the positions at which the compatible keys 83 can be disposed, positions P1 to P8 are defined around the circumference of a reference circle about the positioning projection 81. Positions P1 to P8 are at the same positions in the coupling portion 80 among the toner containers 4a to 4d and are defined at equal intervals (equal angles) around the circumference of the reference circle. In other words, positions P1 to P8 are equally spaced around the circumference of a circle about the positioning projection 81. In the example shown in FIG. 8, position P1 is located adjacently to the upper left of the engagement cylinder 82 and, starting at position P1, positions P2 to P8 are located at equal intervals (equal angles) in the clockwise direction. Positions P1 to P8 are defined to be symmetrical left to right with respect to a vertical line passing through the center of the positioning projection 81.

In this embodiment, as shown in FIG. 8, the compatibility keys 83 of the toner containers 4a to 4d are provided at four positions, namely P1, P2, P4, and P8, out of P1 to P8. The arrangement of the compatibility keys 83 varies depending on the place of destination (shipping destination) of the toner containers 4a to 4d.

As shown in FIG. 9, a boss portion 91 is provided at the center of the coupled portion 90. The boss portion 91 is a cylindrical member protruding from the mounting surface 90a of the coupled portion 90 upstream in the insertion direction (toward the toner container 4d). The boss portion 91 has an insertion hole 91a. The positioning projection 81 (see FIG. 7) provided on the end surface 80a of the coupling portion 80 is inserted into the insertion hole 91a.

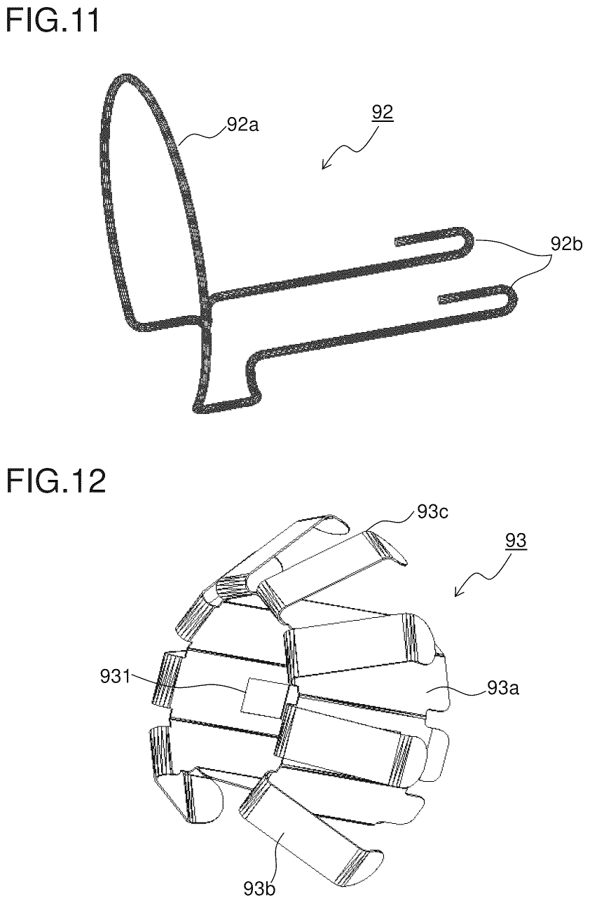

The coupled portion 90 has a first contact spring 92 and a second contact spring 93. FIG. 11 and 12 are perspective views of the first and second contact springs 92 and 93, respectively, attached to the coupled portion 90.

The first contact spring 92 is a wire spring member formed by bending an electrically conductive spring wire material into a predetermined shape and has a contact portion 92a and a connection portion 92b. The contact portion 92a is arc-shaped and is disposed along the outer circumferential edge of the coupled portion 90 as shown in FIG. 9. The connection portion 92b extends from opposite end parts of the contact portion 92a in a direction perpendicular to the plane including the contact portion 92a. The tips of the connection portion 92b are curved in a U-shaped toward the contact portion 92a. One end of a fourth coupling spring 97 is coupled to the contact portion 92a.

The second contact spring 93 is a plate spring member formed by bending an electrically conductive metal plate into a predetermined shape and has a spring body portion 93a and a plurality of contact terminals 93b. Although FIGS. 9 and 12 show the second contact spring 93 with contact terminals 93b formed at eight locations, the actual second contact spring 93 has contact terminals 93b formed at only four of the eight locations corresponding to the compatibility keys 83 of the coupling portion 80.

The spring body portion 93a is cylindrical in shape and, as shown in FIG. 9, is disposed around the circumference of a circle about the boss portion 91. The spring body portion 93a has a positioning hole 931 and an engagement hole 932 (see FIG. 10). The positioning holes 931 are formed in the spring body portion 93a at two opposite locations. The positioning holes 931 position the second contact spring 93 with respect to the coupled portion 90 by fitting around positioning bosses on the coupled portion 90. One end of the second coupling spring 96 (see FIG. 10) is coupled to the engagement hole 932.

The contact terminals 93b are provided adjacent to each other upstream (near left in FIG. 12) of the spring body part 93a in the insertion direction and are disposed to project so as to radiate at predetermined angles radially outward downstream (far right in FIG. 12) in the insertion direction. At the tip end of each contact terminal 93b, a bent portion 93c is formed that is bent at a predetermined angle toward the spring body portion 93a.

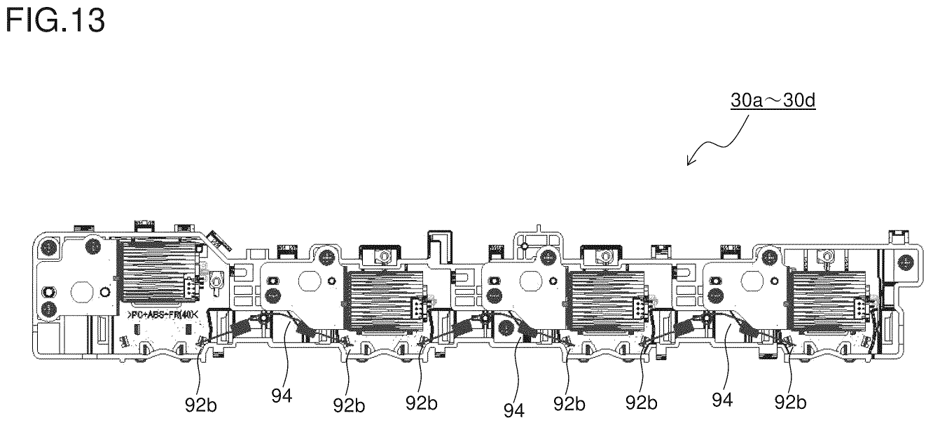

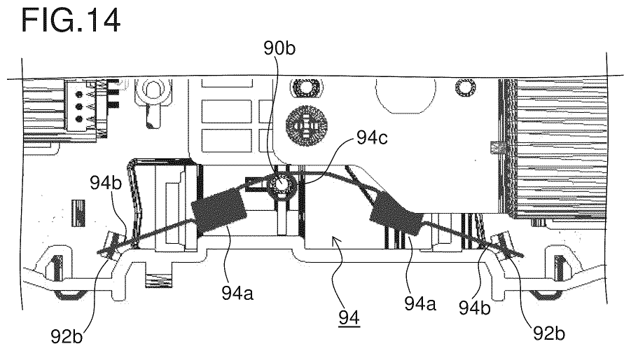

FIG. 13 is a plan view of the coupled portion 90 of the container mounting portions 30a to 30d as viewed from the rear (from opposite the toner containers 4a to 4d). FIG. 14 is an enlarged view around the first coupling spring 94 in FIG. 13. As shown in FIG. 13, the connection portion 92b of the first contact spring 92 protrudes to the rear of the coupled portion 90 at four locations corresponding to the container mounting portions 30a to 30d. There is also provided a first coupling spring 94 that connects together the connecting portions 92b of the adjacent first contact springs 92.

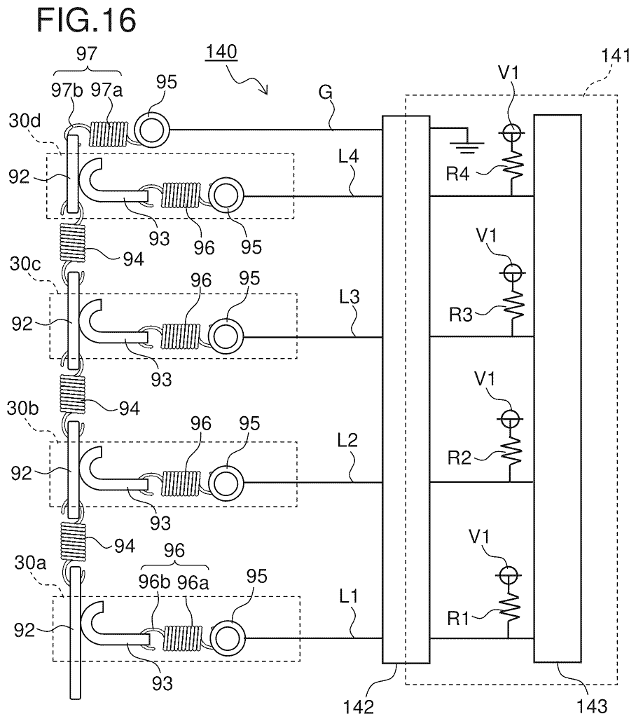

The first coupling spring 94 has two coil spring portions 94a, a pair of hook portions 94b, and a fixed portion 94c. The hook portions 94b extend outward from opposite end parts of the coil spring portion 94a and engage with the connection portion 92b of the first contact spring 92. The fixing portion 94c is an annular portion that is formed between the two coil spring portions 94a and into which the spring fixing boss 90b formed on the rear of the coupled portion 90 is inserted. The first contact spring 92, the second contact spring 93, and the first coupling spring 94 form part of a container detection circuit 140 (see FIG. 16).

This embodiment employs the first contact spring 92 that is a wire spring member formed by bending a spring wire material into a predetermined shape. This eliminates the need to form it by molding using a mold as when the first contact spring 92 is formed of a plate spring. This helps reduce production costs.

The configuration of the coupled portion 90 can also be simplified, and this leads to easier assembly. Specifically, adjacent first contact springs 92 can be easily connected together by simply hooking the hook portions 94b of the first coupling spring 94 on the connection portion 92b of the first contact spring 92.

### [4. Control Paths in the Image Forming Apparatus]

FIG. 15 is a block diagram showing one example of control paths used in the image forming apparatus 100. When the image forming apparatus 100 is used, different parts of the image forming apparatus 100 are controlled in different manners and thus the control paths in the entire image forming apparatus 100 are complex. Thus, the following portion focuses on those of the control paths that are necessary for the implementation of the present disclosure. Also, no description will be repeated for those parts and devices that have already been described.

The container detection circuit 140 has a detection board 141 that is connected to the first and second contact springs 92 and 93 in the container mounting portions 30a to 30d. The container detection circuit 140 checks whether the toner containers 4a to 4d are mounted in the container mounting portions 30a to 30d and checks the compatibility (suitability) of the mounted toner containers 4a to 4d. The configuration of the container detection circuit 140 will be described in detail later.

An image input portion 160 is a receiving portion that receives image data transmitted from a personal computer or the like to the image forming apparatus. An image signal input from the image input portion 160 is converted to a digital signal, which is then fed to a temporary storage portion 194.

An operation portion 170 has a liquid crystal display 171 and LEDs 172. The liquid crystal display 171 indicates the operating state of the image forming apparatus 100, the progress of image formation, the number of copies printed, and the like. The LEDs 172 indicate various states and errors of the image forming apparatus 100. Various settings for the image forming apparatus 100 are made from a printer driver on the personal computer.

The operation portion 170 also has a start button with which the user can request the start of image formation, a stop/clear button that the user uses to stop image formation, a reset button that the user uses to set the various settings on the image forming apparatus 100 back to the default settings.

The control portion 190 at least includes a CPU (central processing unit) 191 as a central arithmetic processor, a ROM (read-only memory) 192 as a memory for reading only, a RAM (random-access memory) 193 as a readable and writeable memory, a temporary storage portion 194 for temporarily storing image data and the like, a counter 195, and a plurality of I/Fs (interfaces) 196 that transmit control signals to different devices in the image forming apparatus 100 and that receive input signals from the operation unit 170. The control portion 190 can be arranged anywhere inside the body of the image forming apparatus 100.

The ROM 192 stores a program for controlling the image forming apparatus 100 and numerical values necessary for control, that is, data and the like that are not changed during the use of the image forming apparatus 100. The RAM 193 stores necessary data produced during the control of the image forming apparatus 100, data temporarily necessary for the control of the image forming apparatus 100, and the like. The temporary memory 194 temporarily stores image signals input via the image input portion 160 and converted into digital signals. The counter 195 counts the number of printed sheets on a cumulative basis.

The control portion 190 transmits control signals from the CPU 191 to different parts and devices in the image forming apparatus 100 through the I/Fs 196. On the other hand, from those parts and devices, signals indicating their status and input signals are transmitted to the CPU 191 through the I/Fs 196. The parts and devices controlled by the control portion 190 include, for example, the image forming portions Pa to Pd, the main motor 110, the belt driving motor 120, the toner supplying motor 130, the container detection circuit 140, the image input portion 160, and the operation portion 170.

### [5. Discrimination Mechanism for Toner Containers]

Next, the discrimination mechanism for the toner containers 4a to 4d will be described. FIG. 16 is a schematic diagram of the container detection circuit 140 used in the image forming apparatus 100 according to this embodiment. The container detection circuit 140 has a detection board 141, a connector 142, signal lines L1 to L4, and a ground line G.

The detection board 141 has a detection IC 143. One ends of the signal lines L1 to L4 are each connected to the detection IC 143 via a connector 142. A power supply V1 is connected to each of the signal lines L1 to L4 via resistors R1 to R4, respectively, between the connector 142 and the detection IC 143.

The other ends of the signal lines L1 to L4 are connected to the second contact springs 93 provided in the coupled portion 90 (see FIG. 9) of the container mounting portions 30a to 30d via round terminals 95 and second coupling springs 96, respectively. The second coupling spring 96 has a coil spring portion 96a and hook portions 96b formed at opposite ends of the coil spring portion 96a. By hooking the hook portions 96b of the second coupling spring 96 on the round terminal 95 and in the engagement hole 932 (see FIG. 10) in the second contact spring 93, the signal lines L1 to L4 and the second contact springs 93 can be easily connected together.

The first contact spring 92 on the coupled portion 90 of the container mounting portions 30a to 30d are connected in series, with the first coupling springs 94 in between. One end of the ground line G is connected to the first contact spring 92 of the container mounting portion 30d via a third coupling spring 97 and the round terminal 95. The third coupling spring 97 has a coil spring portion 97a and hook portions 97b formed at opposite ends of the coil spring portion 97a. By hooking the hook portions 97b of the third coupling spring 97 on the round terminal 95 and on the connection portion 92b of the first contact spring 92, the ground line G and the first contact spring 92 can be easily connected together.

The other end of the ground line G is grounded to be kept at a reference potential (GND) on the detection board 141. The ground line G can be grounded to be kept at a reference potential (GND) outside the detection board 141.

With no toner containers 4a to 4d mounted in any of the container mounting portions 30a to 30d, as shown in FIG. 16, the second contact spring 93 and the first contact spring 92 are in a contacting state in all the coupled portions 90 in the container mounting portions 30a to 30d. Thus, all the signal lines L1 to L4 are grounded via the ground line G, and the voltage (detection signal) applied from the power supply V1 to the signal lines L1 to L4 is at LOW level.

In this case, the control portion 190 judges that no toner containers 4a to 4d are mounted in any of the container mounting portions 30a to 30d. The control portion 190 displays on the liquid crystal display 171 in the operation portion 170 a message indicating that no toner containers 4a to 4d are mounted or a message prompting the user to mount the toner containers 4a to 4d.

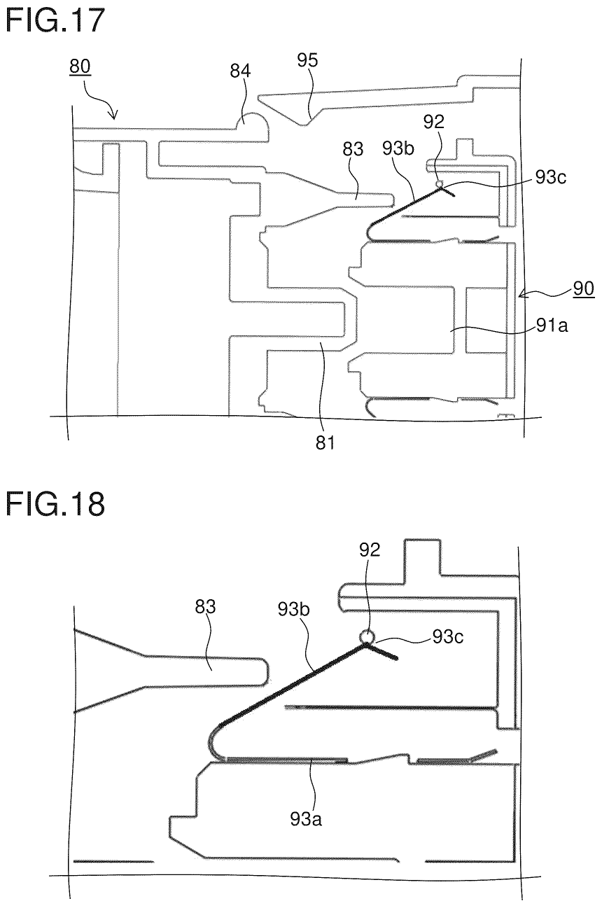

FIG. 17 is a sectional view of the coupling portion 80 of the toner container 4d and the coupled portion 90 of the container mounting portion 30d as cut along the axial direction, showing a state immediately before the toner container 4d reaches the mounting position in the container mounting portion 30d. FIG. 18 is an enlarged view around the first and second contact springs 92 and 93 in FIG. 17. While the following description focuses on the operation of mounting the toner container 4d in the container mounting portion 30d, the operation of mounting the toner containers 4a to 4c in the container mounting portions 30a to 30c is similar.

Before the toner container 4d reaches the mounting position in the container mounting portions 30d (before it is completely mounted), the contact terminal 93b of the second contact spring 93 is in contact with the first contact spring 92 as shown in FIGS. 17 and 18. Specifically, the contact terminal 93b is in contact with the first contact spring 92 at the bent portion 93c. In other words, a conducting state is maintained between the first and second contact springs 92 and 93.

Before the toner container 4d reaches the mounting position, the positioning projection 81 formed on the coupling portion 80 is inserted into the insertion hole 91a in the boss portion 91 of the coupled portion 90. Thus, the coupling portion 80 and the coupled portion 90 are positioned in the radial direction (up-down direction in FIG. 17). The tip ends of the four compatible keys 83 formed on the coupling portion 80 contact the corresponding contact terminals 93b respectively. FIGS. 17 and 18 show only one compatible key 83 and one contact terminal 93b corresponding to it.

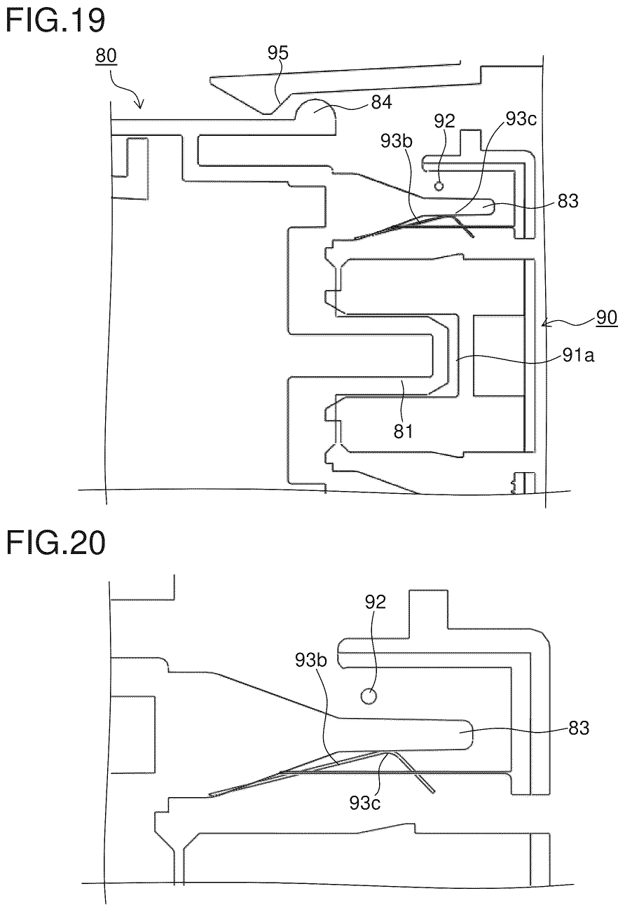

FIG. 19 is a diagram showing a state where the toner container 4d is inserted up to the mounting position in the container mounting portion 30d. FIG. 20 is an enlarged view around the first and second contact springs 92 and 93 in FIG. 19. When from the state shown in FIG. 17 the toner container 4d is further inserted up to the mounting position in the back of the container mounting portion 30d, the engaging portion 84 formed on the coupling portion 80 engages with the engaged portion 95 of the coupled portion 90, and the toner container 4d is positioned in the insertion direction (left-right directions in FIG. 19).

Now, as shown in FIGS. 19 and 20, the tip ends of the four compatible keys 83 formed on the coupling 80 move to between the corresponding ones of the contact terminals 93b and the first contact springs 92, and the first and second contact springs 92 and 93 go into a non-conducting state. Note that FIGS. 19 and 20 show only one compatible key 83 and one contact terminal 93b corresponding to it.

Forming the bent portion 93c in the contact terminal 93b prevents the compatible key 83 from being caught on the tip end of the contact terminal 93b when the compatible key 83 is pulled out of the contact between the contact terminal 93b and the first contact spring 92. While in this embodiment the contact terminal 93b contacts the first contact spring 92 at the bent portion 93c, the contact terminal 93b can contact the first contact spring 92 upstream of the bent portion 93c in the insertion direction.

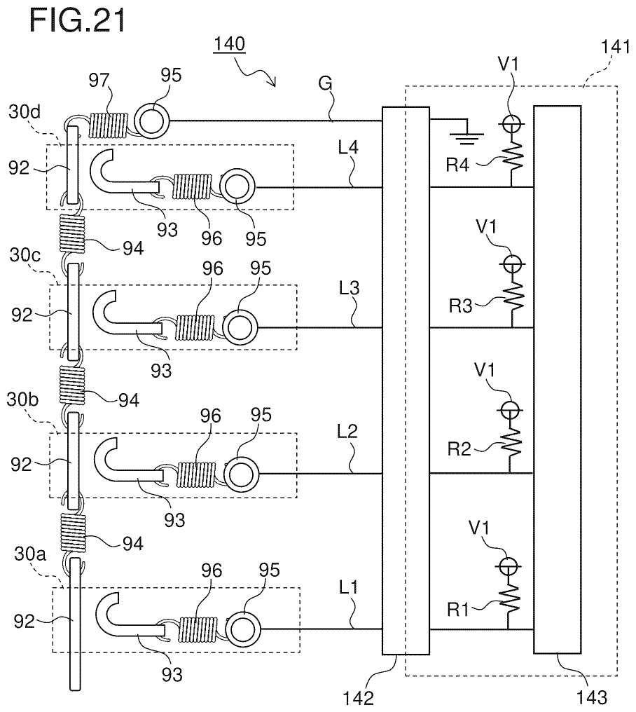

FIG. 21 is a schematic diagram of the container detection circuit 140, showing a state where normal toner containers 4a to 4d are mounted in the container mounting portions 30a to 30d. As shown in FIG. 21, when normal toner containers 4a to 4d are mounted in all of the container mounting portions 30a to 30d, the first and second contact springs 92 and 93 are in a non-contacting state in all the coupled portions 90 of the container mounting portions 30a to 30d. Thus, the signal lines L1 to L4 are not grounded via the ground line G, and the voltage (detection signal) applied to the signal lines L1 to L4 from the power supply V1 is at HIGH level (the supply voltage of the power supply V1).

In this case, the control portion 190 judges that normal toner containers 4a to 4d are mounted in all of the container installation portions 30a to 30d. The control portion 190 now stops displaying on the liquid crystal display 171 of the operation portions 170 the message indicating that no toner containers 4a to 4d are mounted or the message prompting the user to mount the toner containers 4a to 4d. The control portion 190 then enables the image forming apparatus 100 to perform image forming operation. The logic for detection of the toner containers 4a to 4d in the image forming apparatus 100 is shown in Table 1.

TABLE 1

| Container | Level of Detection Signal | |
|---|---|---|
| Mounting Portion | from Detection IC | Container Presence |
| Black | High Level (Supply Voltage) | Present |
| | Low Level | Absent |
| Cyan | High Level (Supply Voltage) | Present |
| | Low Level | Absent |
| Magenta | High Level (Supply Voltage) | Present |
| | Low Level | Absent |
| Yellow | High Level (Supply Voltage) | Present |
| | Low Level | Absent |

If an incompatible toner container 4d is mounted in one of the four containers mounting portions 30a to 30d (e.g., the container mounting portion 30d), some of the contacts between the first contact spring 92 of the coupled portions 90 and the four contact terminals 93b (see FIG. 12) remain in a contacting state. For example, if a toner container 4d with no compatible key 83 at position P2 (see FIG. 8) is mounted in the container mounting portion 30d, only the contact terminal 93b corresponding to position P2 remains in a contacting state, and the other contacts are in a non-contacting state. Thus, the signal line L4 is grounded via the ground line G, and the voltage (detection signal) applied to the signal line L4 from the power supply V1 is at LOW level (GND).

In this case, the control portion 190 cannot detect the toner container 4d even with the toner container 4d mounted in the container mounting portion 30d. That is, the control portion 190 judges that no toner container 4d is mounted even with the toner container 4d mounted. Thus, the control portion 190 assumes that no toner container 4d is mounted and continues to display the message on the liquid crystal display 171 of the operation portions 170. In this case, the maintenance worker who mounted the toner container 4d can, by seeing the message continue to be displayed on the image forming apparatus 100, recognize that the mounted toner container 4d is, or can be, incompatible with the image forming apparatus 100.

This provides a compatibility detection mechanism using the compatibility key 83 and the first and second contact springs 92 and 93, which makes it possible to individually detect incompatible toner containers 4a to 4d in the container mounting portions 30a to 30d. Also, if an incompatible toner container 4a to 4d is mounted, a message continues to be displayed on the liquid crystal display 171 of the operation portion 170. Thus the maintenance worker who mounted the toner containers 4a to 4d can easily recognize that the mounted toner containers 4a to 4d are incompatible, check the toner containers 4a to 4d before image forming operation is performed, and remove the incompatible toner containers 4a to 4d. This eliminates the risk of unsuitable toner being supplied to the image forming portions Pa to Pd and helps reduce printing defects.

While in the above embodiment a color printer that includes toner containers 4a to 4d storing toner of four colors, namely yellow, magenta, cyan, and black, is taken as an example of the image forming apparatus 100, the present disclosure is equally applicable when the image forming apparatus 100 is a monochrome printer.

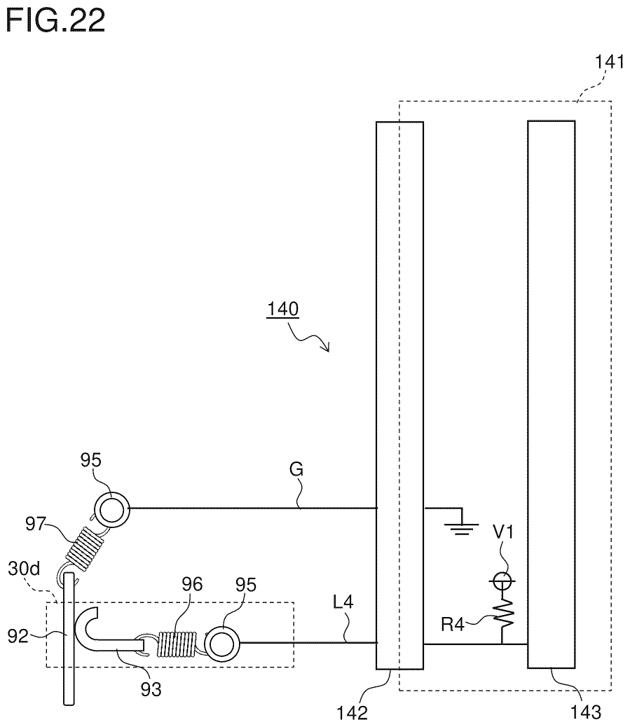

FIG. 22 is a schematic diagram of the container detection circuit 140 used when the image forming apparatus 100 is a monochrome printer. A monochrome printer uses only black toner and accordingly has only the container mounting portion 30d in which the toner container 4d is mounted. Accordingly, the first and second contact springs 92 and 93 are provided one each in the container mounting portion 30d.

One end of the signal line L4 is connected to the detection IC 143 via the connector 142. The other end of the signal line L4 is connected to the second contact spring 93 via the round terminal 95 and the second coupling spring 96. The power supply V1 is connected to the signal line L4 via the resistor R4 between the connector 142 and the detection IC 143. One end of the ground line G is connected to the first contact spring 92 via the third coupling spring 97 and the round terminal 95. The other end of the ground line G is grounded to be kept at a reference potential (e.g., ground potential) on the detection board 141.

When no toner container 4d is mounted in the container mounting portion 30d, as shown in FIG. 22, the second contact spring 93 and the first contact spring 92 are in a contacting state in the coupled portion 90 of the container mounting portion 30d, Thus, the signal line L4 is grounded via the ground line G, and the voltage (detection signal) applied to the signal line L4 from the power supply V1 is at LOW level.

In this case, the control portion 190 judges that no toner container 4d is mounted in the container mounting portion 30d. The control portion 190 displays on the liquid crystal display 171 of the operation portion 170 a message indicating that no toner container 4d is mounted, or a message prompting the user to mount the toner container 4d.

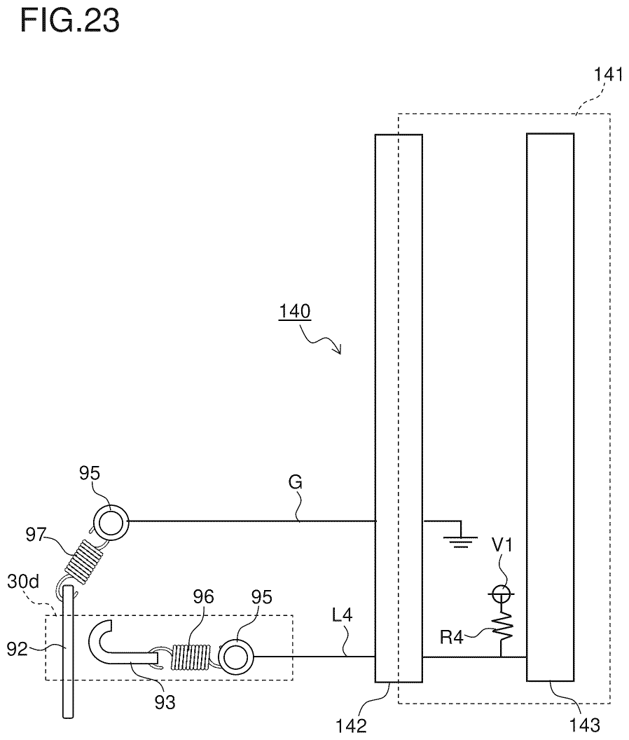

FIG. 23 is a schematic diagram of the container detection circuit 140, showing a state where a normal toner container 4d is mounted in the container mounting portion 30d. As shown in FIG. 23, when a normal toner container 4d is mounted in the container mounting portion 30d, the first and second contact springs 93 are in a non-contacting state in the coupled portion 90 of the container mounting portion 30d. Thus, the signal line LA is not grounded via the ground line G, and the voltage (detection signal) from the power supply V1 to the signal line L4 is at HIGH level (the supply voltage of the power supply V1).

In this case, the control portion 190 judges that a normal toner container 4d is mounted in the container mounting portion 30d. The control portion 190 now stops displaying on the liquid crystal display 171 of the operation portions 170 the message indicating that no toner container 4d is mounted or the message prompting the user to mount the toner container 4d. The control portion 190 then enables the image forming apparatus 100 to perform image forming operation. The logic for detection of the toner container 4d when the image forming apparatus 100 is a monochrome printer is shown in Table 2.

TABLE 2

| Container | Level of Detection Signal | |
|---|---|---|
| Mounting Portion | from Detection IC | Container Presence |
| Black | High Level (Supply Voltage) | Present |
| | Low Level | Absent |

If an incompatible toner container 4d is mounted in the container mounting portion 30d, some of the contacts between the first contact spring 92 and the four contact terminals 93b of the coupled portions 90 remain in a contacting state. For example, if a toner container 4d with no compatible key 83 at position P2 (see FIG. 8) is mounted in the container mounting portion 30d, only the contact terminal 93b corresponding to position P2 remains in a contacting state, and the other contacts are in a non-contacting state. Thus, the signal line L4 is grounded via the ground line G, and the current (detection signal) that passes from the power supply V1 to the detection IC 143 is at LOW level (GND).

In this case, the control portion 190 cannot detect the toner container 4d even with the toner container 4d mounted in the container mounting portion 30d. That is, the control portion 190 judges that no toner container 4d is mounted even with the toner container 4d mounted. Thus, the control portion 190 assumes that no toner container 4d is mounted and continues to display the message on the liquid crystal display 171 of the operation portions 170. In this case, the maintenance worker who mounted the toner container 4d can, by seeing the message continue to be displayed on the image forming apparatus 100, recognize that the mounted toner container 4d is, or can be, incompatible with the image forming apparatus 100.

The embodiments described above are not meant to limit the scope of the present disclosure, which thus allows for any modifications without departure from the spirit of what is disclosed herein. For example, the above embodiment illustrates a toner container 4a to 4d having four compatible keys 83 and a coupled portion 90 having four contact terminals 93b, but the numbers and positions of compatible keys 83 and contact terminals 93b are not limited to those in the above configuration.

The embodiment described above deals with an example where a coupling portion 80 is provided in the cap member 42. Instead, for example, if the toner containers 4a to 4d do not include a cap member 42, the coupling portion 80 can be formed integrally with in the container body 40 of the toner containers 4a to 4d.

The embodiment described above deals with toner containers 4a to 4d that are mounted in an image forming apparatus 100 including developing devices 3a to 3d of a two-component development type that use two-component developer containing magnetic carrier and toner and that store toner to supply to the developing devices 3a to 3d. However, the present disclosure is equally applicable to toner containers that store toner to supply to developing devices of a magnetic one-component development type that use magnetic toner or of a non-magnetic one-component development type that use non-magnetic toner.

The present disclosure is applicable not only to tandem-type color printers as shown in FIG. 1 but also to various image forming apparatuses that use toner containers, such as color copiers, color MFPs, monochrome printers and copiers, and monochrome MFPs.

The present disclosure finds applications in image forming apparatuses including a toner storage container that stores toner. Based on the present disclosure, it is possible to provide an image forming apparatus that is free from detection failure due to a damaged compatibility detection shape and that can determine the compatibility of a toner storage container with a simple and inexpensive configuration.

What is claimed is:

1. An image forming apparatus comprising:
an image forming portion that performs image formation on a recording medium using toner;
a toner storage container that stores the tonner used in the image forming portion;
a mounting portion in which the toner storage container is removably mounted;
a detection mechanism that detects the toner storage containers mounted in the mounting portion; and
a control portion that enables the image forming portion to perform image forming operation when the detection mechanism detects the toner storage container, wherein
the toner storage container has a coupling portion in a downstream end part thereof in an insertion direction into the mounting portion,
the mounting portion has a coupled portion that couples to the coupling portion when the toner storage container is inserted up to a predetermined mounting position,
the detection mechanism has:
a detection circuit including:
a first contact spring provided in the coupled portion;
a second contact spring having a plurality of contact terminals that contact the first contact spring;
a ground line to one end of which the first contact spring is connected and of which another end is grounded;
a signal line to which the second contact spring is connected;
a power supply connected to the signal line, and
a detection board having a detection portion that detects a voltage applied from the power supply to the signal line as a detection signal; and
a plurality of electrically insulating key members provided in the coupling portion and protruding toward the coupled portion,
with the toner storage container removed from the mounting position, the first contact spring and the contact terminals are in a contacting state,
when the toner storage container is inserted up to the mounting position, the key member moves to between the first contact spring and the contact terminals such that the first contact spring and the contact terminals turn from the contacting state to a non-contacting state, and
when the first contact spring and the contact terminals turn from the contacting state to the non-contacting state, the control portion detects the toner storage container mounted in the mounting portion based on a change in the detection signal detected by the detecting portion.

2. The image forming apparatus according to claim 1, wherein:
a plurality of the image forming portions which perform image formation using the toner of a plurality of colors;
a plurality of the toner storage containers that store the toner of colors corresponding to the image forming portions;
a plurality of the mounting portions in which the toner storage containers are removably mounted; and
the detection mechanism that detects the toner storage containers mounted in the plurality of mounting portions,
wherein
the signal line is connected to the second contact spring individually in the plurality of mounting portions,
the control portion detects the toner storage containers mounted in the mounting portions individually based on a change in the detection signal passing across a plurality of the signal lines.

3. The image forming apparatus according to claim 2, wherein:
the plurality of toner containers have a different pattern of arrangement of the key members disposed in the coupling portion for each place of destination of the toner containers,
in the coupled portion of the plurality of mounting portions, the contact terminals are disposed at a position corresponding to the arrangement pattern of the key members in the corresponding toner storage containers.

4. The image forming apparatus according to claim 2, wherein:
a first coupling spring that connects together a plurality of the first contact springs, wherein
the plurality of first contact springs are connected in series to the ground line via the first coupling spring.

5. The image forming apparatus according to claim 4, wherein
the first contact spring has:
a contact portion that is arc-shaped; and
a connection portion extending from opposite end parts of the contact portion in a direction crossing a plane including the contact portion, the connection portion having a tip end curved in a U-shape toward the contact portion, and
the first coupling spring has:
a coil spring portion; and
a pair of hook portions extending outward from opposite ends of the coil spring portion and engaging with the connection portion.

6. The image forming apparatus according to claim 1, wherein:
a second coupling spring that connects together the second contact spring and the signal line; and
a third coupling spring that connects together the first contact spring and the ground line.

7. The image forming apparatus according to claim 4, wherein
the second coupling spring has:
a coil spring portion; and
a pair of hook portions extending outward from opposite ends of the coil spring portion and engaging with an engagement hole formed in the second contact spring and with a round terminal coupled to the signal line.

8. The image forming apparatus according to claim 6, wherein
the third coupling spring has:
a coil spring portion; and
a pair of hook portions extending outward from opposite ends of the coil spring portion and engaging with the connection portion formed in the first contact spring and with a round terminal coupled to the ground line.
